(19) United States
(12) Patent Application Publication
(10) Pub. No.: US 2017/0103434 A1
(43) Pub. Date: Apr. 13, 2017

(54) AUTOMATIC TAXONOMY ALIGNMENT

(71) Applicant: PayPal, Inc., San Jose, CA (US)

(72) Inventors: Daniel Hurwitz, Kfar Saba (IL); Ram Nov, Tzur-Yigal (IL); Alex Zhicharevich, Givaataim (IL)

(21) Appl. No.: 14/878,047

(22) Filed: Oct. 8, 2015

(51) Int. Cl. G06Q 30/06; G06F 17/30

(52) U.S. Cl. CPC G06Q 30/0601; G06F 17/30589; G06F 17/30424; G06F 17/30598; G06F 17/3053

(57) ABSTRACT

A method of posting a listing submitted with respect to a first electronic commerce system onto a second electronic commerce system is disclosed. A submission of the listing is received for posting in association with a target category included in a taxonomy of the first electronic commerce system. Category confidence scores are generated pertaining to strengths of correspondences between the target category and each of a set of candidate matching categories included in a taxonomy of the second electronic commerce system. At least one of the candidate matching categories is selected as an actual matching category. The selecting is communicated for posting of the listing in association with the actual matching category included in the taxonomy of the second electronic commerce system in addition to the posting of the listing in association with the target category included in the taxonomy of the first electronic commerce system.

### TECHNICAL FIELD

The present application relates generally to the technical field of data store and data structure management, and, in one specific example, to aligning a taxonomy of categories associated with a first computer system and a taxonomy of categories associated with a second computer system.

### BACKGROUND

Electronic commerce systems may facilitate trading of items (e.g., products or services) using computer networks. Different electronic commerce systems may provide different marketplace user experiences, each designed to serve different target users. For example, there may be electronic commerce systems designed specifically to serve users who are located within particular geographical regions, speak particular languages, have particular demographics, have particular interests, and so on. Furthermore, various market forces, including supply and demand forces, may shape each electronic commerce system, resulting in different quantities and types of items listed for trading within each electronic commerce system.

### BRIEF DESCRIPTION OF THE DRAWINGS

Some embodiments are illustrated by way of example and not limitation in the figures of the accompanying drawings.

FIG. 1 is a network diagram depicting a client-server system within which various example embodiments may be deployed.

FIG. 2 is a block diagram illustrating multiple applications that, in one example embodiment, are provided as part of the networked systems of FIG. 1.

FIG. 3 is a flow diagram illustrating an example method of posting a listing submitted with respect to a first electronic commerce system onto a second electronic commerce system.

FIG. 4 is a flow diagram illustrating an example method of, based on an identified correspondence between a first category and a second category, expanding a dictionary of attributes and attribute values associated with the second category.

FIG. 5 is a flow diagram illustrating an example method of calculating a confidence score pertaining to a similarity between the first category and the second category.

FIG. 6 is a screenshot of an example user interface in which output of a taxonomy management application(s) is presented.

FIG. 7 is a screenshot of an example user interface in which further output of the taxonomy management application(s) is presented.

FIG. 8 is a screenshot of an example user interface in which further output of the taxonomy management application(s) is presented.

FIG. 9 is a block diagram of machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

In example embodiments, each electronic commerce system is associated with a different taxonomy of product categories. The taxonomy may include or be defined as a set of product categories arranged in a hierarchy. Each category may be associated with attribute names and attribute values corresponding to each of the attribute names. For example, a category for women's dresses may be associated with attribute names such as “brand” or “size.” Values corresponding to the brand attribute may include “Calvin Klein,” “Guess,” and so on. Values corresponding to the size attribute may include typical size numbers for women's dresses, such as numbers ranging from 0-20. An attribute and a value assigned to the attribute for a particular listing are referred to as an attribute-value pair. Thus, for example, a listing for a women's dress may be associated with the attribute value pair of Brand=Calvin Klein and the attribute value pair of Size=2. In addition, a category in the taxonomy may inherit attribute-value pairs belonging to its parent nodes (categories) located higher up in the hierarchy.

A seller listing an item on an electronic commerce system (e.g., as for sale or available for auction) associates the listing with a category in the taxonomy corresponding to the electronic commerce system. The electronic commerce system then communicates with additional electronic commerce systems to notify the additional electronic commerce systems to not only make the listing available to potential buyers within the additional electronic commerce systems, but also make the listing available at an appropriate node of different taxonomies associated with the additional electronic commerce systems.

Additionally, based on differences between the taxonomies of the various electronic commerce systems, dictionaries of attribute names and attribute values are communicated between the electronic commerce systems such that each of the dictionaries includes additional possibilities that were not contemplated organically within each of the electronic commerce systems individually. For example, although two electronic commerce systems may include an attribute name of “brand” that is associated with a common category, the possible values of the brands within the two electronic commerce systems may not overlap with each other (e.g., based on supply and demand market forces within each system). Furthermore, two attributes belonging to two separate electronic commerce systems whose taxonomies are in identical languages may describe a similar intent yet be named differently (e.g., “brand” versus “manufacturer”). Thus, a more complete dictionary of possible brand values is incorporated by each electronic commerce system based on communications received from other electronic commerce systems within a set of networked electronic commerce systems.

In various embodiments, multiple electronic commerce systems are different instances of an electronic commerce system (e.g., deployed in different geographical regions, focusing on different items, or focusing on different users). For example, an electronic commerce system such as eBay has multiple systems or sites for different regions (e.g., U.S., France, and U.K.), different products (e.g., automotive products, fashion products, valet services, same-day delivery services), or different audiences (e.g., English speakers, French speakers, Spanish speakers). The categories in the taxonomies associated with each instance or separate system represent subjects and types of items that are listed on each site. Each category and item is associated with different attributes, such as brand, size, etc., depending on the item. Each category or item is associated with attribute name-value pairs (e.g., “size=3,” “brand=Guess,” and so on) stored in their respective languages.

In various embodiments, a goal of a taxonomy alignment system is to determine which categories on a first site correspond to categories on a second site and which name-value pairs on a first site correspond to name-value pairs on the second site.

In various embodiments, the name-value pairs associated with a listing are chosen by a seller of a listing (e.g., from a dictionary of name-value pairs associated with items of the type or a category in the taxonomy with which the item is associated). In various embodiments, the taxonomy and a dictionary of name-value pairs are stored in a data store and maintained by the taxonomy alignment system. In various embodiments, the taxonomy is organically created by sellers of items or manually created or edited by a content team (e.g., administrators responsible for maintaining a taxonomy). Thus, each taxonomy associated with each different system may take on a different category structure and dictionary of name-value pairs associated with each category.

In various embodiments, modules of the taxonomy alignment system are implemented in a programming language, such as Java. The modules may use a framework for parallel processing of data in a distributed environment, such as Hadoop. In various embodiments, as a simplification, three different modules handle solving the problems of category alignment, attribute alignment, and value alignment, respectively between separate taxonomies maintained by different instances of an electronic commerce systems or separate electronic commerce systems. However, in some cases, the logic of these modules will be intertwined and as such one module's solution can require utilizing a feedback loop from other modules in order to improve the final alignment quality.

In various embodiments, a confidence score representing a similarity between a first category and a second category is generated, wherein the first category is included in a taxonomy of a first electronic commerce system and the second category is included in a taxonomy of a second electronic commerce system. The confidence score may be based on information specified in data fields associated with listings of items posted by sellers and associated with the first category or the second category. Such data fields may correspond to titles, descriptions, item specifics (e.g., attribute-value pairs), and so on. For example, the seller may specify a title for each listing. The titles for a set of listings associated with the first category are compared with the titles for a set of listings associated with the second category. The confidence score is then based on how similar the titles are (e.g., after they are translated into a common language).

In various embodiments, for every possible pair of categories in a taxonomy trees of two sites, the taxonomy alignment system takes all of the listings that are listed in the categories. For example, for the first site, the taxonomy alignment system may aggregate all of the tokens/words that appear in the titles of listings for a target category. Then, the taxonomy alignment system may do the same for a target candidate matching category on the other site.

For category alignment, the system may also utilize pre-computed attribute alignment results (i.e., similarity scores between attribute names, values, or name-value pairs) and incorporate them into an inclusive category similarity metric.

The confidence score represents a confidence that the two categories are similar or identical to each other (e.g., on a scale from 0 to 1, with 0 corresponding to no similarity and 1 corresponding to identical). Thus, for example, if the aggregation of keywords for a category in the taxonomy of the first site is the same as the aggregation of keywords for a category in the taxonomy of the second site, the confidence score may be “1” (representing the strongest confidence). If, on the other hand, there are no shared keywords in the aggregations, the confidence score may be “0” (representing the weakest confidence). As another example, the confidence score may depend at least partially on a percentage of shared keywords between the aggregated keyword lists.

In various embodiments, the size of the set of keywords specified in the listing and other listings associated with the target category is constrained to a threshold number of keywords that are specified most often in the listing and the other listings associated with the target category.

For sites using a common language (e.g., an American site and a British site), there may not be a need for language translation. However, for sites using different languages, the sets of tokens are translated into one of the languages or a common third language. In other words, the token sets are translated into a translated token sets.

In various embodiments, the translations are performed automatically by a translation engine. Translations can be done through a specially-programmed translation module, by calls to a Machine Translation API (e.g., of one of the application(s) 120a, 120b, 122a, or 122b), or using a free or paid translation engine, such as the Google Translate API.

In various embodiments, the translations might be included in alignment results output such that a content specialist (e.g., an administrator) can use them for insight into the quality of the algorithm's identified or suggested alignment or suggested enrichment of a target taxonomy dictionary (e.g., with new attribute names or attribute-value pairs). Thus, in various embodiments, the content specialist may curate or approve identified or suggested alignment changes.

Different market characteristics and inventories lead to different taxonomy structures for different sites. For example, in the U.S. for stamps listings, there may be a category for each U.S. state. However, in France or England, there may be only one category for listings of U.S. stamps.

The taxonomies may be derived from submissions of sellers or created manually by separate site administrators based on the culture and inventories that the site represents. For example, in the U.K., there may be less emphasis on baseball collectibles than in the U.S. (e.g., instead of category listings for each baseball team, there just may be a general category for sports collectibles).

In various embodiments, for each category, a subset of the aggregated token list is used (e.g., the most used 30 or 50 tokens). For baseball cards, the words may be “baseball,” “cards,” baseball player names, and so on. On the other hand, similar tokens may appear in a general category for sports collectibles. Thus, baseball collectibles for one site may be mapped to general sports collectibles in a second site with a certain amount of confidence.

For a given set of categories having a confidence score that transgresses a confidence threshold value (e.g., fairly confident the categories are identical or extremely similar to each other, such as a confidence score of 0.7 or higher), the confidence scores are further adjusted based on a comparison of the attribute name-value pairs associated with the set of categories. For example, each category is associated with a set of attribute name-value pairs derived from items listed in the category or a content team. The names of the attributes and the values corresponding to the attributes (with translations performed, as necessary) are compared. If the attribute names, attribute name-value pairs, or values are similar, a bonus may be added to the category confidence score. In various embodiments, similarities in names of attributes may be compared separately from similarities in possible values assignable to each attribute within the two taxonomies that are being analyzed and for which the confidence score is being calculated.

The taxonomy alignment system can be used in several ways. For example, a seller in Germany uploads a listing for an item onto a German web site. Based on a determination that a German category with which the listing is associated on the German site corresponds to a category on the U.S. site, the German listing can also be included on the U.S. site, making the item available across markets.

Additionally, the taxonomy alignment system improves attribute name-value dictionaries used on each site. For example, under women's dresses on a U.S. site, a set of brands may have 50 names. In a matching category in a U.K. site, another 40 brands that do not overlap with the brands on the U.S. site may be used. Thus, the correspondence between the categories can be used to augment the dictionary of attributes on the benefitting site with additional values, exposing the users of the site to more content and thus enriching the overall user experience.

Similarly, the correspondence between the categories can be used to improve the possible attributes corresponding to a category, in addition to the values associated with those attributes. For example, under a Toys & Hobbies/Stuffed Animals category for a first site, attributes may include Brand, Character Family, Recommended Age Range, Size, Gender, Type, Year, manufacture part number (MPN), and Country/Region of Manufacture. If the second site does not include all of those attributes in association with a matching category, the second site may update its list of attributes corresponding to the matching category to include the attributes of the matching category on the first site, as well as values for any added attributed.

A similar process may be used to improve the sets of values corresponding to each attribute. For example, the possible sets of values for each attribute may be improved based on a comparison of differences between sets of possible values used for similar attributes in separate taxonomies.

The confidence score may also be used to suggest to the content team or sellers additional possibilities with regard to how the categories of a site are arranged. For example, the organization of the categories from a top level down to bottom levels may be compared across sites, with a visualization presented to an administrator of the site showing the differences. The administrator may then elect to modify the taxonomy of a site based on the taxonomy of the other site, or not. In other embodiments, the updates may be made automatically (e.g., based on predetermined or administrator-set thresholds or tolerances).

In various embodiments, a method of posting a listing submitted with respect to a first electronic commerce system onto a second electronic commerce system is disclosed. A submission of the listing is received for posting in association with a target category included in a taxonomy of the first electronic commerce system. Category confidence scores are generated pertaining to strengths of correspondences between the target category and each of a set of candidate matching categories included in a taxonomy of the second electronic commerce system. At least one of the candidate matching categories is selected as an actual matching category. The selecting is communicated for posting of the listing in association with the actual matching category included in the taxonomy of the second electronic commerce system in addition to the posting of the listing in association with the target category included in the taxonomy of the first electronic commerce system.

In various embodiments, alignment between attributes, attribute-value pairs, or possible values may also be identified (e.g., based on a matching of a target category to a corresponding matching category).

In various embodiments, no candidate matching category (or attribute name or attribute-value pair) may be selected (e.g., if none of the confidence scores are above a given threshold). Such non-selection may be justified because a source category may have no similar category in the target taxonomy. For example, a category describing items pertaining to a specific American holiday in a taxonomy for an American site may not have a matching category in a taxonomy for a non-American site. As another, a target category whose intent overlaps so very slightly with one or more candidate matching categories should, in some cases, rightfully not be aligned at all. Such a target category may be aligned to a “null” category of a taxonomy of a different site (or, in other words, not aligned at all).

In various embodiments, one or more modules are incorporated into a networked system to perform one or more of the various operations or algorithms described herein. The one or more modules may be implemented by one or more processors of the networked system. In various embodiments, instructions corresponding to one or more of the various operations or algorithms described herein are included on a machine readable medium. The instructions, when executed by one or more processors of a machine, causes the machine to perform the various operations.

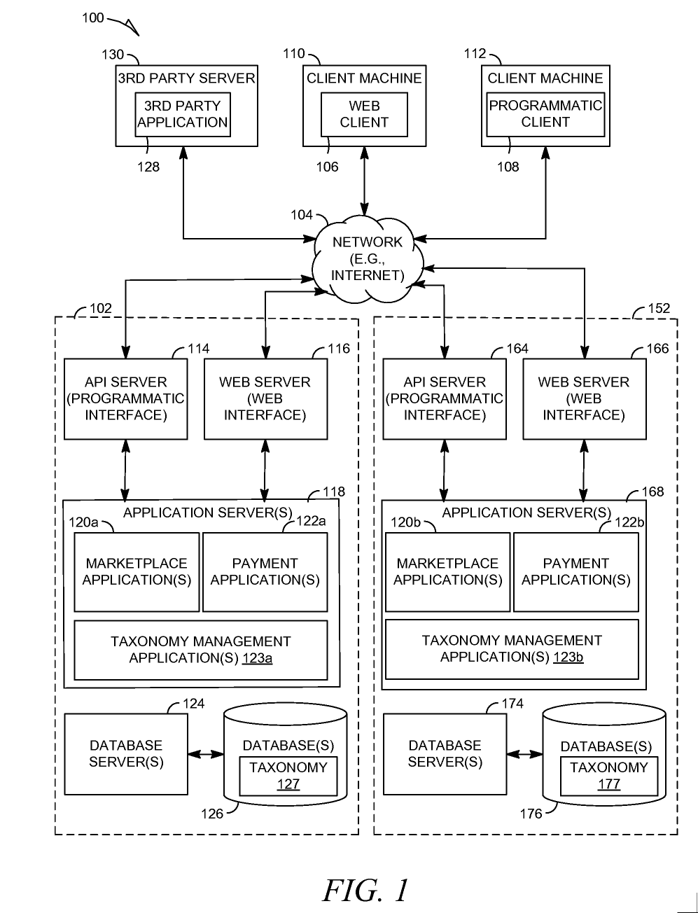

FIG. 1 is a network diagram depicting a client-server system 100, within which various example embodiments may be deployed. A networked system 102, in the example form of a network-based publication system or other communication system, provides server-side functionality, via a network 104 (e.g., the Internet or Wide Area Network (WAN)) to one or more clients. FIG. 1 illustrates, for example, a web client 106 (e.g., a browser, such as the Internet Explorer browser developed by Microsoft Corporation of Redmond, Washington) and a programmatic client 108 executing on respective client machines 110 and 112. Each of the one or more clients machines 110, 112 includes a software application module (e.g., a plug-in, add-in, or macro) that adds a specific service or feature to a larger system.

Within the networked system 102, an API server 114 and a web server 116 are coupled to, and provide programmatic and web interfaces respectively to, one or more application servers 118. The application servers 118 host one or more applications, such as marketplace application(s) 120a, payment application(s) 122a, and taxonomy management application(s) 123a. In various embodiments, the taxonomy management application(s) 123a manage a taxonomy 127 that is associated with the networked system 102. This management of the taxonomy 127 includes identifying or modifying an alignment of the taxonomy 127 with respect to another taxonomy of another networked system, such as a taxonomy 177 of a networked system 152, as described in more detail below. The application servers 118 are, in turn, shown to be coupled to one or more databases servers 124 that facilitate access to one or more databases or NoSQL or non-relational data stores 126.

The networked system 152, in the example form of an additional network-based publication system, an additional instance of the networked system 102, or another communication system, provides server-side functionality, via a network 104 to the one or more client machines 110, 112.

Within the networked system 152, an API server 164 and a web server 166 are coupled to, and provide programmatic and web interfaces respectively to, one or more application servers 168. The application servers 168 host one or more applications, such as marketplace application(s) 120b, payment application(s) 122b, and taxonomy management application(s) 123b. In various embodiments, the taxonomy management application(s) 123b manages the taxonomy 177 that is associated with the networked system 152. This management of the taxonomy 177 includes identifying or modifying an alignment of the taxonomy 177 with respect to another taxonomy of another networked system, such as the taxonomy 127 of the networked system 102, as described in more detail below. The application servers 168 are, in turn, shown to be coupled to one or more databases servers 174 that facilitate access to one or more databases or NoSQL or non-relational data stores 176.

The applications 120a, 120b, 122a, 122b, 123a, and 123b provide a number of functions and services to users who access the networked systems 102 and 152. While the applications are shown in FIG. 1 to form part of the networked systems 102 and 152, in alternative embodiments, the applications may form part of a service that is separate and distinct from the networked systems 102 and 152.

Further, while the system 100 shown in FIG. 1 employs a client-server architecture, various embodiments are, of course, not limited to such an architecture, and could equally well find application in a distributed, or peer-to-peer, architecture system, for example. The various applications could also be implemented as standalone software programs, which do not necessarily have computer networking capabilities. Additionally, although FIG. 1 depicts machines 130, 110, and 112 as being coupled to a networked system 102 and networked system 152, it will be readily apparent to one skilled in the art that machines 130, 110, and 112, as well as client applications 128, 106, and 108, may be coupled to multiple additional networked systems. For example, the client applications 128, 106, and 108 may be coupled to multiple applications, such as payment applications 122a and 122b, which may be associated with multiple payment processors (e.g., Visa, MasterCard, and American Express).

The web client 106 accesses the various applications 120a, 120b, 122a, 122b, 123a, and 123b via the web interface supported by the web server 116 or the web server 166, respectively. Similarly, the programmatic client 108 accesses the various services and functions provided by the applications 120a, 120b, 122a, 122b, 123a, and 123b via the programmatic interface provided by the API server 114 and API server 164, respectively. The programmatic client 108 may, for example, perform batch-mode communications between the programmatic client 108 and the networked systems 102 and 152.

FIG. 1 also illustrates a third party application 128, executing on a third party server machine 130, as having programmatic access to the networked systems 102 and 152 via the programmatic interface provided by the API server 114 and the API server 164, respectively. For example, the third party application 128 may, utilizing information retrieved from the networked systems 102 and 152, support one or more features or functions on a website hosted by the third party. The third party website may, for example, provide one or more promotional, social-networking, or payment functions that are supported by the relevant applications of the networked system 102.

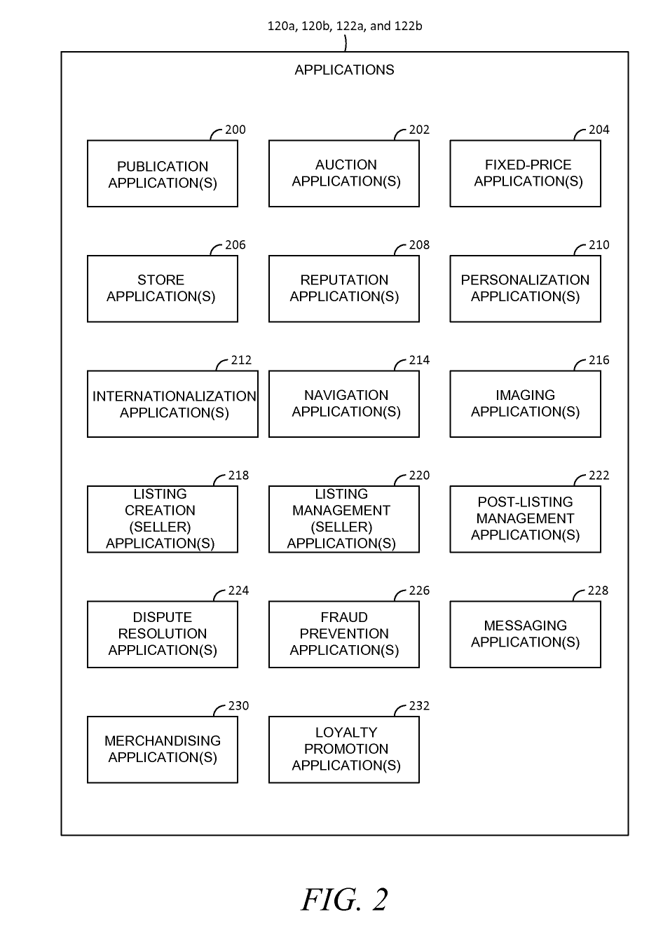

FIG. 2 is a block diagram illustrating multiple applications 120a, 120b, 122a, 122b, 123a, and 123b that, in one example embodiment, are provided as part of the networked system 102. The applications 120a, 120b, 122a, 122b, 123a, and 123b may be hosted on dedicated or shared server machines (not shown) that are communicatively coupled to enable communications between server machines. The applications 120a, 120b, 122a, 122b, 123a, and 123b themselves, are communicatively coupled (e.g., via appropriate interfaces) to each other and to various data sources, so as to allow information to be passed between the 120a, 120b, 122a, 122b, 123a, and 123b, or so as to allow the applications 120a, 120b, 122a, 122b, 123a, and 123b to share and access common data. The applications 120a, 120b, 122a, 122b, 123a, and 123b furthermore access one or more databases 126 and 176 via the database servers 124 and 174, respectively.

Taxonomy management applications(s) 123a and 123b maintain the taxonomies 127 and 177 in the databases 126 and 177 for the networked systems 102 and 152, respectively. In various embodiments, the taxonomy management application(s) 123a and 123b communicate with each other to perform various functions, including improving the taxonomies associated with each of the networked system 102 and 152 (e.g., based on a comparison of the differences between the taxonomies), determining correspondences between different categories in each taxonomy (e.g., based on a comparison of titles of listings included in each category of each taxonomy, a comparison of attribute names associated with each category, a comparison of attribute-value pairs associated with each category, or a comparison of possible values for each attribute defined for each category), improving associations of attribute, attribute-value pairs, or possible values per attribute for each category, and so on, as described in more detail below.

The networked systems 102 and 152 provide a number of publishing, listing and price-setting mechanisms whereby a seller lists (or publish information concerning) goods or services for sale, a buyer expresses interest in or indicates a desire to purchase such goods or services, and a price set for a transaction pertaining to the goods or services. To this end, in FIG. 2, the marketplace and payment 120a, 120b, 122a, and 122b are shown to include at least one publication application 200 and one or more auction applications 202, which support auction-format listing and price setting mechanisms (e.g., English, Dutch, Vickrey, Chinese, Double, Reverse auctions). The various auction applications 202 may also provide a number of features in support of such auction-format listings, such as a reserve price feature whereby a seller may specify a reserve price in connection with a listing, and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users that transact, utilizing the networked system 102, to establish, build, and maintain reputations, which may be made available and published to potential trading partners. Consider that where, for example, the networked systems 102 and 152 support person-to-person trading, users may otherwise have no history or other reference information whereby the trustworthiness and credibility of potential trading partners may be assessed. The reputation applications 208 allow a user (for example through feedback provided by other transaction partners) to establish a reputation within the networked systems 102 and 152 over time. Other potential trading partners may then reference such a reputation for the purposes of assessing credibility and trustworthiness.

Personalization applications 210 allow users of the networked systems 102 and 152 to personalize various aspects of their interactions with the networked systems 102 and 152. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked systems 102 and 152 and other parties.

The networked systems 102 and 152 support a number of marketplaces that are customized, for example, for specific geographic regions. A version (or instance) of the networked system 102 or 152 may be customized for the United Kingdom, whereas another version of the networked system 102 or 152 may be customized for the United States. Each of these versions operates as an independent marketplace, or may be customized (or internationalized) presentations of a common underlying marketplace. The networked systems 102 and 152 may accordingly include a number of internationalization applications 212 that customize information (and/or the presentation of information) by the networked systems 102 and 152 according to predetermined criteria (e.g., geographic, demographic or marketplace criteria). For example, the internationalization applications 212 may be used to support the customization of information for a number of regional websites that are operated by the networked systems 102 and 152 and that are accessible via respective web servers 116 and 166 (FIG. 1).

Navigation of the networked systems 102 and 152 is facilitated by one or more navigation applications 214. In order to make listings available via the networked systems 102 and 152 as visually informing and attractive as possible, the marketplace and payment applications 120a, 120b, 122a, and 122b includes one or more imaging applications 216, which users utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked systems 102 and 152, and listing management applications 220 allow sellers to manage such listings. Specifically, where a particular seller has authored or published a large number of listings, the management of such listings may present a challenge. The listing management applications 220 provide a number of features (e.g., auto-relisting, inventory level monitors) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 provides an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of operations in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked systems 102 and 152. These messages may, for example, advise users regarding the status of listings at the networked systems 102 and 152 (e.g., providing “outbid” notices to bidders during an auction process or providing promotional and merchandising information to users). Respective messaging applications 228 utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked systems 102 and 152. The merchandising applications 230 also operate the various merchandising features that may be invoked by sellers, and may monitor and track the success of merchandising strategies employed by sellers.

The networked system 102 or 152 itself, or one or more parties that transact via the networked system 102 or 152, may operate loyalty programs that are supported by one or more loyalty/promotion applications 232. For example, a buyer may earn loyalty or promotions points for each transaction established or concluded with a particular seller, and may be offered a reward for which accumulated loyalty points can be redeemed.

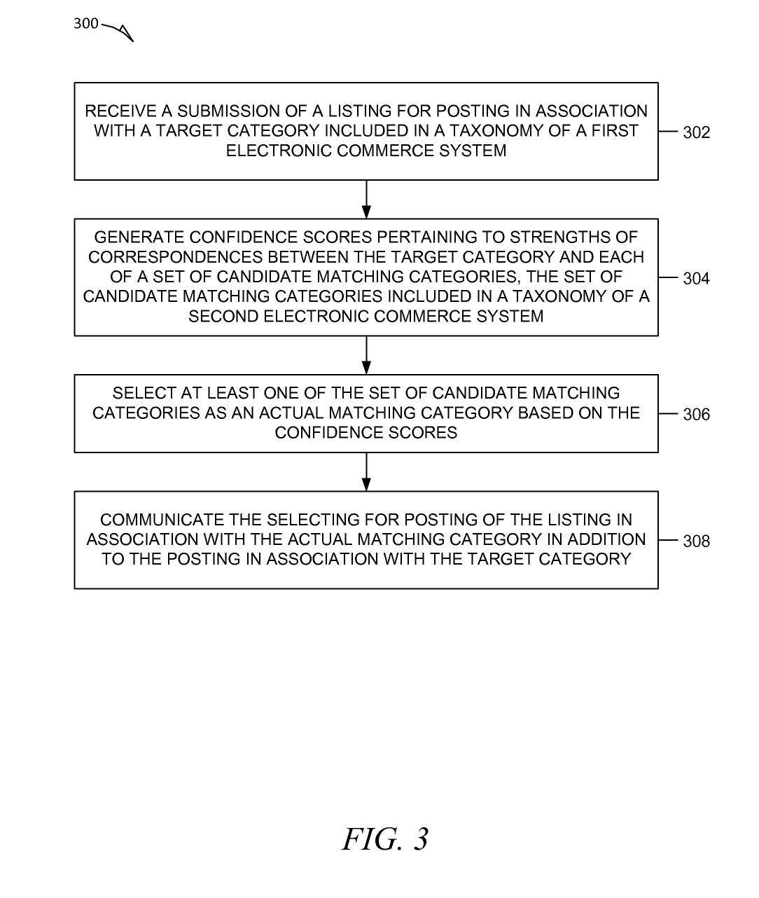

FIG. 3 is a flow diagram illustrating an example method 300 of posting a listing submitted with respect to a first electronic commerce system onto a second electronic commerce system. In various embodiments, the operations of method 300 are implemented by the taxonomy management application(s) 123a and 123b.

At operation 302, the taxonomy management application(s) 123a and 123b receive notification of a submission of a listing for posting in association with a target category included in a taxonomy of a first electronic commerce system. For example, a user of the first electronic commerce system submits a listing for an item and manually specifies a target category for association with the listing. In various embodiments, the user selects the target category from a set of possible target categories. In various embodiments, the set of possible target categories are determined by a content team (e.g., administrators) or the set of possible target categories may be derived from target categories previously submitted for association with previous listings by other users.

At operation 304, the taxonomy management application(s) 123a and 123b generate confidence scores pertaining to strengths of correspondences between the target category and each of a set of candidate matching categories. Here, the set of candidate matching categories are included in a taxonomy of a second electronic commerce system. Thus, for example, if the taxonomy of the first electronic commerce system was developed for a market in the U.K., strengths of correspondences between the target category and a set of candidate matching categories of a taxonomy for a second electronic commerce system that was developed for a different market (e.g., France or the United States) are calculated.

The confidence score is based on one or more factors, such as a similarity between the name of the target categories and the set of candidate matching categories, a similarity in keywords used in data fields of the listings (e.g., the title, description) included in the target category and the set of candidate matching categories, a similarity in names of attributes associated with the target category in comparison to names of the attributes associated with the set of candidate matching categories, and a similarity in values corresponding to the attributes associated with the target category in comparison to values corresponding to the attributes associated with the set of candidate categories. In various embodiments, different weightings may be assigned to each of the factors such that one or more factors are given more importance than the others in the calculation of the confidence scores. Thus, for example, similarities in names of categories may be given higher importance than similarities between names of attributes associated with the categories, or vice versa, in determining the confidence score.

In various embodiments, the category names, attribute names, value names, keywords, and so on corresponding to the first electronic commerce system are translated into a language of the second electronic commerce system, or vice versa, or translated into third language, such that language differences are minimized with respect to analysis of the similarity factors.

At operation 306, the taxonomy management application(s) 123a and 123b select at least one of the set of candidate matching categories as an actual matching category based on the confidence scores. Thus, for example, the target category may be matched to a candidate matching category of the set of candidate matching categories having a highest confidence score. Alternatively, the target category may be matched to multiple ones of the set of candidate matching categories based on the confidence score for each of the multiple ones of the candidate matching categories transgressing a threshold confidence value.

At operation 308, information pertaining to the selection of the candidate matching categories is communicated. Various operations may be performed in response to the communication, including a cross-posting of the listing with respect to the selected candidate matching categories in addition to the target category or, as described below, an updating of a dictionary of attributes or values of attributes corresponding to the candidate matching categories or the target category.

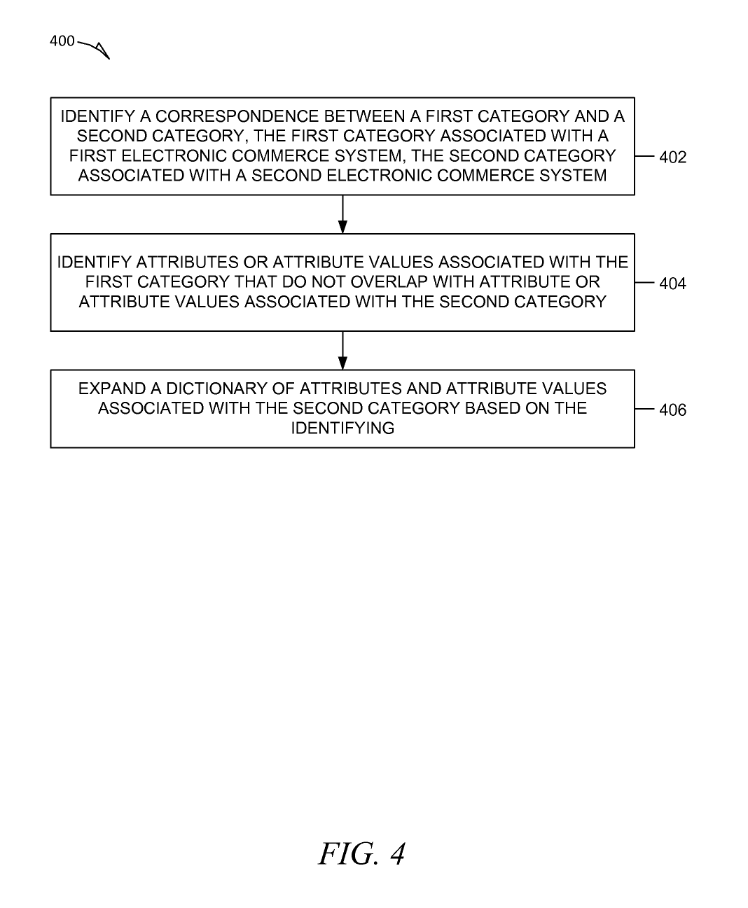

FIG. 4 is a flow diagram illustrating an example method 400 of, based on an identified correspondence between a first category and a second category, expanding a dictionary of attributes and attribute values associated with the second category. Here, the first category is associated with a taxonomy of a first electronic commerce system and the second category is associated with a taxonomy of a second electronic commerce system. In various embodiments, the operations of method 400 are implemented by the taxonomy management application(s) 123a and 123b.

At operation 402, a correspondence between a first category and a second category is identified (e.g., based on a confidence score), the first category associated with the taxonomy of the first electronic commerce system, the second category associated with the taxonomy of the second electronic commerce system.

At operation 404, attributes or attribute name-value pairs associated with the first category that do not overlap with attributes or attribute name-value pairs of the second category are identified.

At operation 406, a dictionary of attributes or attribute name-value pairs associated with the second category is expanded to include at least some of the identified attributes or attribute name-value pairs associated with the first category that do not overlap with the attributes or attribute name-value pairs of the second category. For example, in various embodiments, an administrator of the second electronic commerce system may be presented with a user interface for optionally selecting particular ones of the non-overlapping attributes or attribute name-value pairs for inclusion in the second taxonomy.

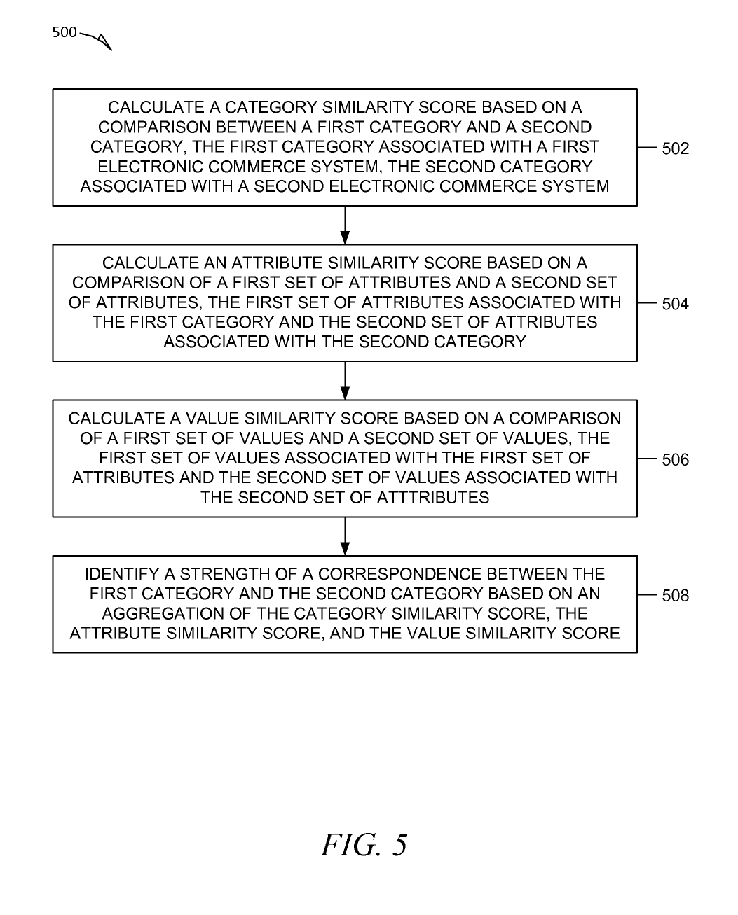

FIG. 5 is a flow diagram illustrating an example method 500 of calculating a confidence score pertaining to a similarity between a first category and a second category. The method 500 may correspond to operation 304. In various embodiments, the operations of method 500 are implemented by the taxonomy management application(s) 123a and 123b.

At operation 502, a category similarity score is calculated based on a comparison between a first category and a second category. Here, the first category is associated with the first electronic commerce system and the second category is associated with the second electronic commerce system. In various embodiments, the category similarity score may be based on comparisons of value specified in fields of listings associated with each category, as described above.

At operation 504, an attribute similarity score is calculated based on a comparison of a first set of attributes and a second set of attributes. Here, the first set of attributes is associated with the first category and the second set of attributes is associated with the second category. For example, the names of the attributes may be translated into a common language and compared to determine the attribute similarity score.

At operation 506, a value similarity score is calculated based on a comparison of a first set of values and a second set of values. Here, the first set of values is associated with the first set of attributes and the second set of value is associated with the second set of attributes. For example, the names of the sets of values may be translated into a common language and compared. Additionally, the relationship of the first set of values to the first set of attributes may be compared to the relationship between the second set of values and the second set of attributes. Thus, the value similarity score may represent how similarly the values are organized with respect to their corresponding attributes within each taxonomy.

At operation 508, a strength of a correspondence between the first category and the second category is identified. The strength of a correspondence between the first category and the second category may be based on an aggregation of the category similarity score, the attribute similarity score, and the value similarity score (e.g., into a total confidence score). The aggregation may be based on a weighted average of the scores, such that, for example, the category similarity score carries more weight than the attribute similarity score and the attribute similarity score carries more weight than the value similarity score.

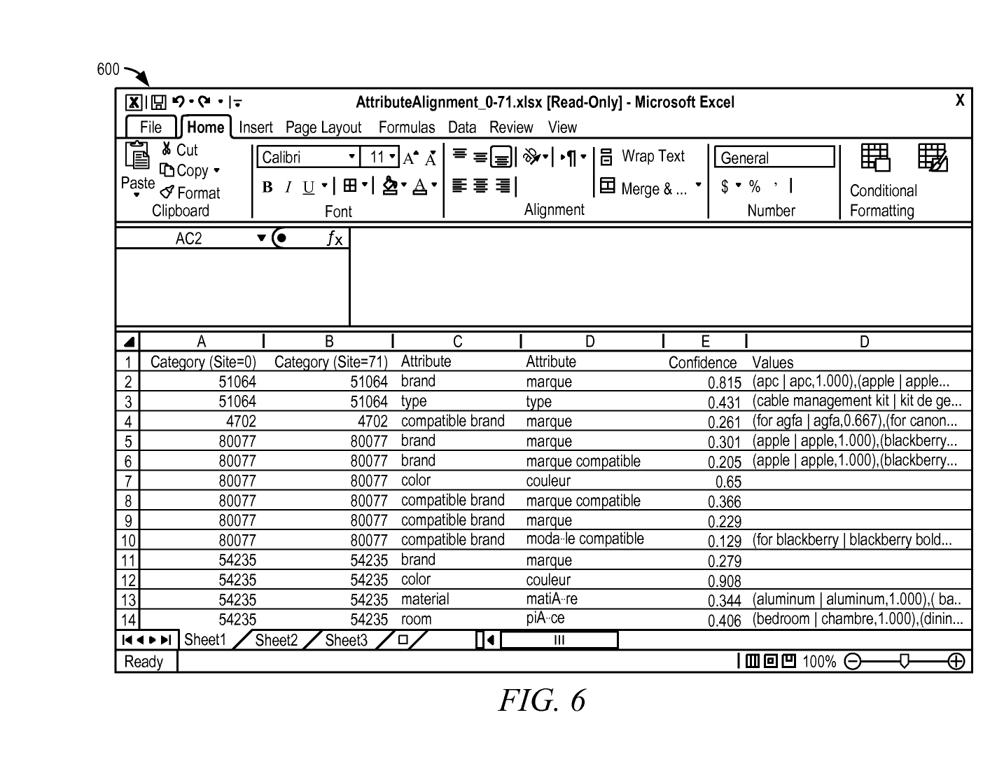

FIG. 6 is a screenshot of an example user interface 600 in which output of the taxonomy management application(s) 123a and 123b is presented. Here, the attributes corresponding to categories of taxonomies of two different sites are compared. The first site (“Site=0”) is a U.S.-based electronic commerce site. The second site (“Site=71”) is a French-based electronic commerce site.

Column A of the user interface 600 includes identifiers of target categories of Site 0. Column B includes identifiers of candidate matching categories of Site 71. Column C includes names of attributes from Site 0 corresponding to the target categories. Column D includes names of attributes from Site 71 corresponding to the candidate matching categories. Column E includes confidence scores pertaining to the attribute similarities. Column F includes confidence scores pertaining to value similarities, which may be used as a basis for determining the confidence scores pertaining to the attribute similarities, as described above. Column F includes a comma delimited list of entries in the format (target_value1|candidate_matching_value1,score), where the score is the confidence score pertaining to the similarity between the target value and the candidate matching value.

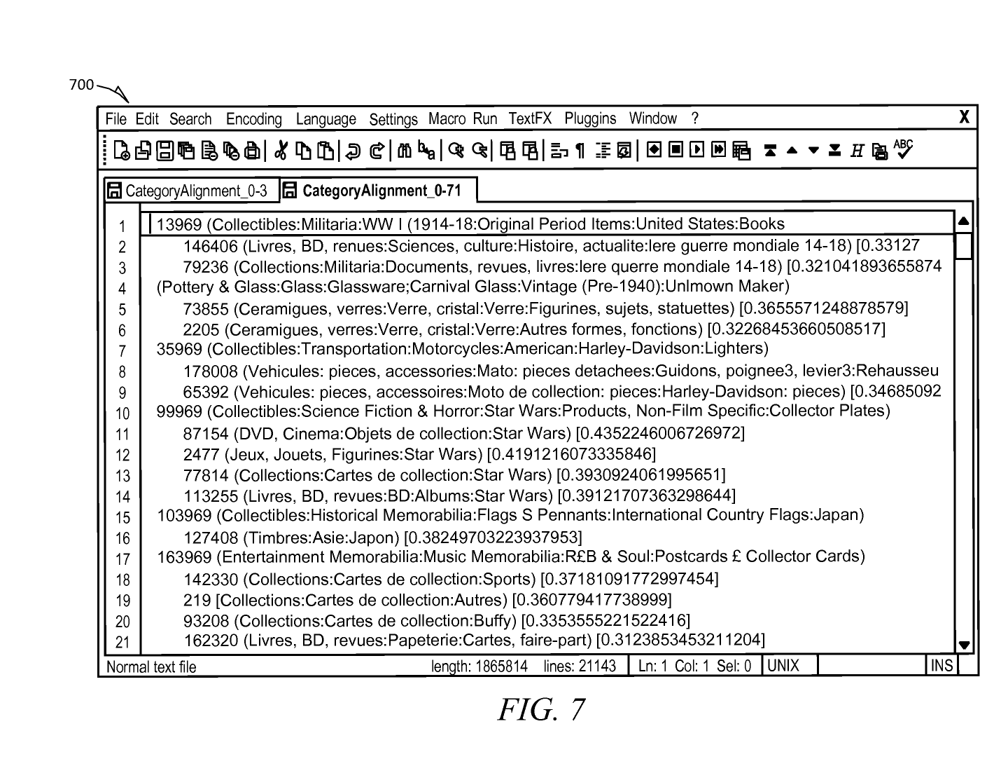

FIG. 7 is a screenshot of an example user interface 700 in which further output of the taxonomy management application(s) 123a and 123b is presented. Here, the categories associated with the taxonomies of two different sites are compared. The first site is a U.S.-based site and the second site is a French-based site. Each line of the output is formatted as such: [internal category ID] (category taxonomy tree breadcrumb—Level1:Level2: . . . :Level N) [generated confidence score]. The indented lines are suggested candidate matching category alignment mappings to the target category (the non-indented line above it).

Thus, for example, the category on the U.S. site having the category ID 33969 (Pottery & Glass:Glass:Glassware:Carnival Glass:Vintage (Pre-1940):Unknown Maker) has two candidate matching categories on the French site: category ID 178008 (with a confidence score of 0.356) and category ID 65392 (with a confidence score of (0.347). In various embodiments, these may be the only two candidate matching categories transgressing confidence score threshold (e.g., 0.34).

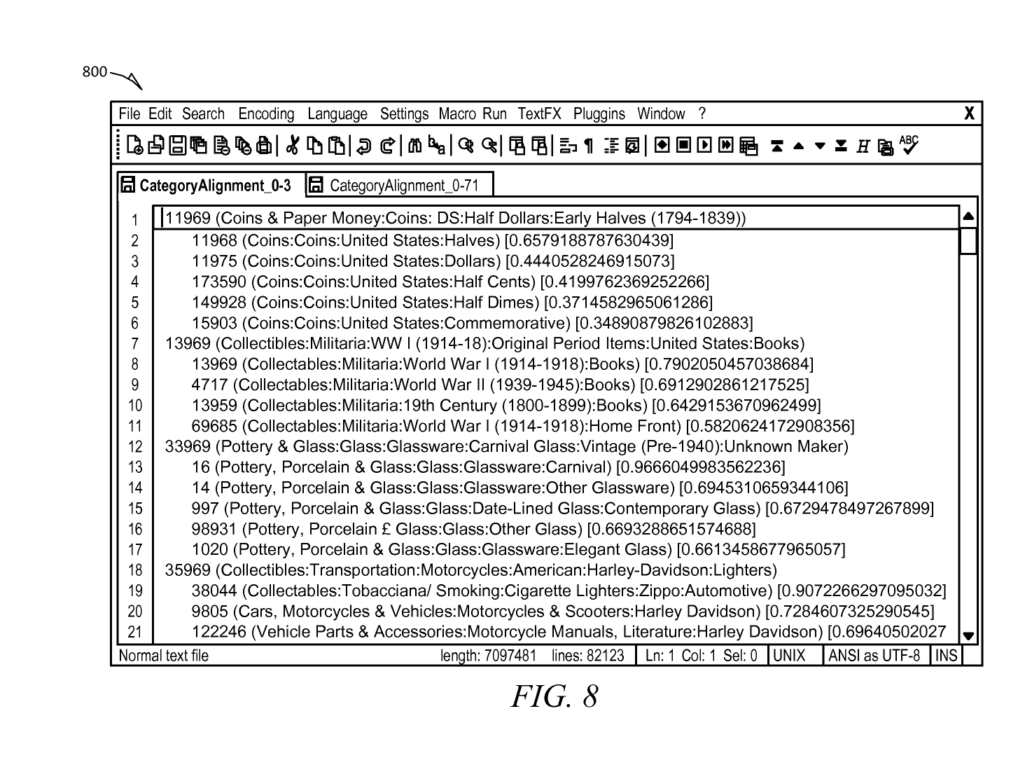

FIG. 8 is a screenshot of an example user interface 800 in which further output of the taxonomy management application(s) 123a and 123b is presented. Here, the categories associated with the taxonomies of two different sites are compared. The first site is a U.S.-based site and the second site is a U.K.-based site.

Here, the same category ID 33969 depicted in FIG. 7 has five candidate matching categories on the U.K. site: 16 (with a confidence score of 0.967), 14 (with a confidence score of 0.695), 997 (with a confidence score of 0.673), 98931 (with a confidence score of 0.669), and 1020 (with a confidence score of 0.661). In various embodiments, these may be the only five candidate matching categories transgressing a confidence score threshold (e.g., 0.66). In various embodiments, the candidate matching categories may also be limited to a top number of closest matches (e.g., five).

Certain embodiments are described herein as including logic or a number of components, modules, or mechanisms. Modules may constitute either software applications, software modules (e.g., code embodied on a machine-readable medium or in a transmission signal). or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a central processing unit or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a processor configured using software, the processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, for example, a computer program tangibly embodied in an information carrier, (e.g., in a machine-readable medium) for execution by, or to control the operation of, data processing apparatus (e.g., a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

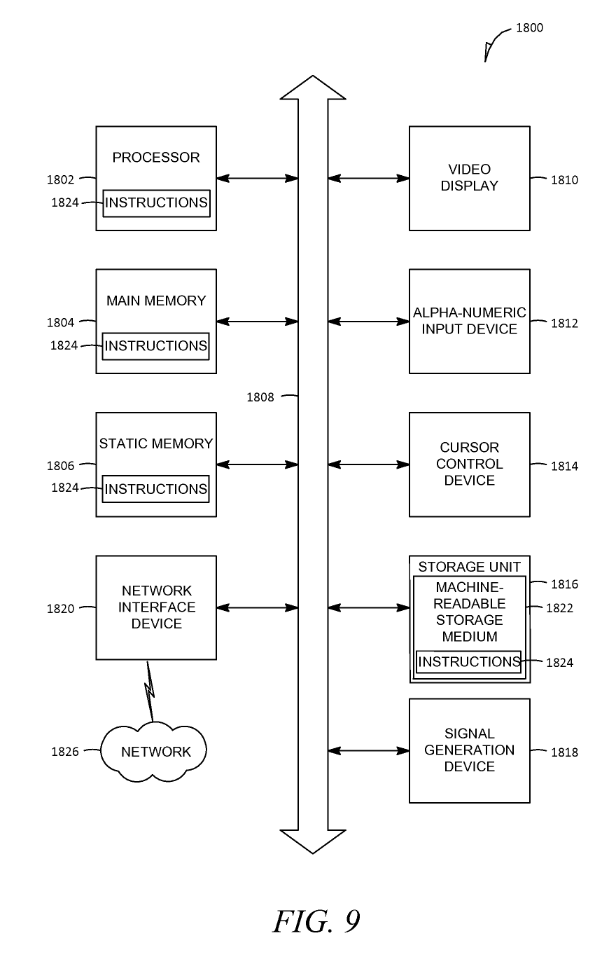

FIG. 9 is a block diagram of machine in the example form of a computer system 1800 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1800 includes a processor 1802 (e.g., a central processing unit (CPU), a graphics processing unit (GPU) or both), a main memory 1804 and a static memory 1806, which communicate with each other via a bus 1808. The computer system 1800 may further include a video display unit 1810 (e.g., a liquid crystal display (LCD) or a cathode ray tube (CRT)). The computer system 1800 also includes an alphanumeric input device 1812 (e.g., a keyboard), a user interface (UI) navigation (or cursor control) device 1814 (e.g., a mouse), a storage unit 1816, a signal generation device 1818 (e.g., a speaker) and a network interface device 1820.

The storage unit 1816 includes a machine-readable medium 1822 on which is stored one or more sets of data structures and instructions 1824 (e.g., software) embodying or utilized by any one or more of the methodologies or functions described herein. The instructions 1824 may also reside, completely or at least partially, within the main memory 1804 and/or within the processor 1802 during execution thereof by the computer system 1800, the main memory 1804 and the processor 1802 also constituting machine-readable media. The instructions 1824 may also reside, completely or at least partially, within the static memory 1806.

While the machine-readable medium 1822 is shown in an example embodiment to be a single medium, the term “machine-readable medium” may include a single medium or multiple media (e.g., a centralized or distributed database, or associated caches and servers) that store the one or more instructions 1824 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, for example, Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

Accordingly, a “tangible machine-readable medium” may refer to a single storage apparatus or device, as well as “cloud-based” storage systems or storage networks that include multiple storage apparatus or devices. Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 1824 may further be transmitted or received over a communications network 1826 using a transmission medium. The instructions 1824 may be transmitted using the network interface device 1820 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible media to facilitate communication of such software. The network 1826 may be one of the networks 104.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of posting a listing submitted with respect to a first electronic commerce system onto a second electronic commerce system, the method comprising:
receiving a submission of the listing at the first electronic commerce system for posting in association with a target category included in a taxonomy of the first electronic commerce system, the taxonomy stored as a data structure in a data store associated with the first electronic commerce system;
generating category confidence scores pertaining to strengths of correspondences between the target category and each of a set of candidate matching categories, the set of candidate matching categories included in a taxonomy of the second electronic commerce system, the taxonomy of the second electronic commerce system stored as a data structure in a data store associated with the second electronic commerce system, the generating of the category confidence scores based on similarities between a set of keywords specified in the listing and other listings posted in association with the target category and a set of keywords specified in listings posted in association with each of the set of candidate matching categories;
selecting at least one of the set of candidate matching categories as an actual matching category included in the taxonomy of the second electronic commerce system based on the confidence scores; and
communicating the selecting to the second electronic commerce system for posting of the listing in association with the actual matching category included in the taxonomy of the second electronic commerce system in addition to the posting of the listing in association with the target category included in the taxonomy of the first electronic commerce system, the posting of the listing in association with the actual matching category to include an updating of an additional data structure in the data store associated with the second electronic commerce system, the additional data structure including references to other listings posted in association with the actual matching category.

2. The method of claim 1, further comprising generating attribute name confidence scores pertaining to strengths of correspondences between attribute names associated with the listing and the other listings associated with the target category and attribute names associated with each of the candidate matching categories and wherein the selecting of the at least one of the candidate matching categories as an actual matching category is further based on the attribute name confidence scores.

3. The method of claim 1, further comprising generating attribute value confidence scores pertaining to strengths of correspondences between attribute values associated with the listing and the other listings associated with the target category and attribute values associated with each of the candidate matching categories and wherein the selecting of the at least one of the candidate matching categories as an actual matching category is further based on the attribute value confidence scores.

4. The method of claim 1, wherein the size of the set of keywords specified in the listing and other listings associated with the target category is constrained to a threshold number of keywords that are specified most often in the listing and the other listings associated with the target category.

5. The method of claim 1, further comprising identifying the similarities between the set of keywords specified in the listing and other listings posted in association with the target category and the set of keywords specified in the listings posted in association with each of the set of candidate matching categories based on a frequency with which each of the set of keywords is specified in the listing and other listings posted in association with the target category and a frequency with which each of the set of keywords is specified in the listings posted in association with each of the set of candidate matching categories.

6. The method of claim 1, further comprising communicating a set of attribute-value pairs associated by the first electronic commerce system with the target category for association by second electronic commerce system with the actual matching category, the communicating of the set of attribute-values pair based on an identification of a lack of association of the attribute-value pair by the second electronic commerce system with the actual matching category.

7. The method of claim 1, wherein:
the set of keywords specified in the listing and other listings posted in association with the target category are in a first language and the set of keywords specified in the listings posted in association with each of the set of candidate matching categories are in a second language, and
the generating of the category confidence scores is further based on a translation confidence score associated with a translation from the second language into the first language of each of the set of keywords specified in the listings posted in association with each of the set of candidate matching categories.

8. A system comprising:
one or more modules incorporated into a first electronic commerce system, the one or more modules implemented by one or more processors of the first electronic commerce system, the one or more modules configured to, at least:
receive a submission of a listing for posting in association with a target category included in a taxonomy of the first electronic commerce system, the taxonomy stored as a data structure in a data store associated with the first electronic commerce system;
generate category confidence scores pertaining to strengths of correspondences between the target category and each of a set of candidate matching categories, the set of candidate matching categories included in a taxonomy of a second electronic commerce system, the taxonomy of the second electronic commerce system stored as a data structure in a data store associated with the second electronic commerce system, the generating of the category confidence scores based on similarities between a set of keywords specified in the listing and other listings posted in association with the target category and a set of keywords specified in listings posted in association with each of the set of candidate matching categories;
select at least one of the set of candidate matching categories as an actual matching category included in the taxonomy of the second electronic commerce system based on the confidence scores; and
communicate the selecting to the second electronic commerce system for posting of the listing in association with the actual matching category included in the taxonomy of the second electronic commerce system in addition to the posting of the listing in association with the target category included in the taxonomy of the first electronic commerce system, the posting of the listing in association with the actual matching category to include an updating of an additional data structure in the data store associated with the second electronic commerce system, the additional data structure including references to other listings posted in association with the actual matching category.

9. The system of claim 8, the one or more modules further configured to generate attribute name confidence scores pertaining to strengths of correspondences between attribute names associated with the listing and the other listings associated with the target category and attribute names associated with each of the candidate matching categories and wherein the at least one of the candidate matching categories is selected as an actual matching category based on the attribute name confidence scores.

10. The system of claim 8, the one or more modules further configured to generate attribute value confidence scores pertaining to strengths of correspondences between attribute values associated with the listing and the other listings associated with the target category and attribute values associated with each of the candidate matching categories and wherein the at least one of the candidate matching categories is selected as an actual matching category based on the attribute value confidence scores.

11. The system of claim 8, wherein the size of the set of keywords specified in the listing and other listings associated with the target category is constrained to a threshold number of keywords that are specified most often in the listing and the other listings associated with the target category.

12. The system of claim 8, the one or more modules further configured to identify the similarities between the set of keywords specified in the listing and other listings posted in association with the target category and the set of keywords specified in the listings posted in association with each of the set of candidate matching categories based on a frequency with which each of the set of keywords is specified in the listing and other listings posted in association with the target category and a frequency with which each of the set of keywords is specified in the listings posted in association with each of the set of candidate matching categories.

13. The system of claim 8, the one or more modules further configured to communicate a set of attribute value pairs associated by the first electronic commerce system with the target category for association by second electronic commerce system with the actual matching category, the communicating of the set of attribute values pair based on an identification of a lack of association of the attribute-value pairs by the second electronic commerce system with the actual matching category.

14. The system of claim 8, wherein:
the set of keywords specified in the listing and other listings posted in association with the target category are in a first language and the set of keywords specified in the listings posted in association with each of the set of candidate matching categories are in a second language, and
the generating of the category confidence scores is further based on a translation confidence score associated with a translation from the second language into the first language of each of the set of keywords specified in the listings posted in association with each of the set of candidate matching categories.

15. A non-transitory machine readable medium comprising a set of instructions that, when executed by one or more processors of a machine, causes the machine to perform operations comprising:
receiving a submission of the listing at the first electronic commerce system for posting in association with a target category included in a taxonomy of the first electronic commerce system, the taxonomy stored as a data structure in a data store associated with the first electronic commerce system;
generating category confidence scores pertaining to strengths of correspondences between the target category and each of a set of candidate matching categories, the set of candidate matching categories included in a taxonomy of the second electronic commerce system, the taxonomy of the second electronic commerce system stored as a data structure in a data store associated with the second electronic commerce system, the generating of the category confidence scores based on similarities between a set of keywords specified in the listing and other listings posted in association with the target category and a set of keywords specified in listings posted in association with each of the set of candidate matching categories;
selecting at least one of the set of candidate matching categories as an actual matching category included in the taxonomy of the second electronic commerce system based on the confidence scores; and
communicating the selecting to the second electronic commerce system for posting of the listing in association with the actual matching category included in the taxonomy of the second electronic commerce system in addition to the posting of the listing in association with the target category included in the taxonomy of the first electronic commerce system, the posting of the listing in association with the actual matching category to include an updating of an additional data structure in the data store associated with the second electronic commerce system, the additional data structure including references to other listings posted in association with the actual matching category.

16. The non-transitory machine readable medium of claim 15, wherein the operations further comprise generating attribute name confidence scores pertaining to strengths of correspondences between attribute names associated with the listing and the other listings associated with the target category and attribute names associated with each of the candidate matching categories and wherein the selecting of the at least one of the candidate matching categories as an actual matching category is further based on the attribute name confidence scores.

17. The non-transitory machine readable medium of claim 15, wherein the operations further comprise generating attribute value confidence scores pertaining to strengths of correspondences between attribute values associated with the listing and the other listings associated with the target category and attribute values associated with each of the candidate matching categories and wherein the selecting of the at least one of the candidate matching categories as an actual matching category is further based on the attribute value confidence scores.

18. The non-transitory machine readable medium of claim 15, wherein the size of the set of keywords specified in the listing and other listings associated with the target category is constrained to a threshold number of keywords that are specified most often in the listing and the other listings associated with the target category.

19. The non-transitory machine readable medium of claim 15, wherein the operations further comprise identifying the similarities between the set of keywords specified in the listing and other listings posted in association with the target category and the set of keywords specified in the listings posted in association with each of the set of candidate matching categories based on a frequency with which each of the set of keywords is specified in the listing and other listings posted in association with the target category and a frequency with which each of the set of keywords is specified in the listings posted in association with each of the set of candidate matching categories.

20. The non-transitory machine readable medium of claim 15, wherein the operations further comprise communicating a set of attribute value pairs associated by the first electronic commerce system with the target category for association by second electronic commerce system with the actual matching category, the communicating of the set of attribute values pair based on an identification of a lack of association of the attribute-value pairs by the second electronic commerce system with the actual matching category.
